(19) United States
(12) Patent Application Publication
(10) Pub. No.: US 2015/0006370 A1
(43) Pub. Date: Jan. 1, 2015

(54) MEDIUM PROCESSING APPARATUS AND METHOD AND FINANCIAL DEVICE

(71) Applicant: LG CNS CO., LTD., Seoul (KR)

(72) Inventor: Jungin LEE, Seoul (KR)

(21) Appl. No.: 14/315,538

(22) Filed: Jun. 26, 2014

(30) Foreign Application Priority Data
Jun. 26, 2013 (KR) 10-2013-0073830

(51) Int. Cl. G06Q 40/02

(52) U.S. Cl. CPC G06Q 40/02
USPC 705/39

(57) ABSTRACT

A medium processing apparatus is provided. The medium processing apparatus comprises a medium depositing and withdrawing unit through which a medium is deposited or withdrawn, a detection unit to acquire an image of the medium, a memory in which reference information, for determining whether the medium is rejected, is stored, and a control unit to extract a portion of information from the acquired image to compare the extracted information with the reference information stored in the memory.

### CROSS-REFERENCE TO RELATED APPLICATIONS

This application claims the benefit under 35 U.S.C. §119 of Korean Patent Application No. 10-10-2013-0073830, filed Jun. 26, 2013, which are hereby incorporated by reference in their entirety.

### BACKGROUND

The present disclosure relates to a medium processing apparatus and method and a financial device.

Generally, financial devices are devices that automatically process financial business that is desired by a customer. The financial devices may deposit or withdraw media (for example, paper moneys, checks, securities, gift certificates, and the like) or automatically transfer the media.

Such a financial device comprises a medium depositing/withdrawing unit for depositing or withdrawing a medium and a medium storage box. The medium may be deposited through the medium depositing and withdrawing unit and then stored in the medium storage box, and the medium stored in the medium storage box may be withdrawn through the medium depositing and withdrawing unit.

In the case where the customer's financial business is automatically processed, a management target medium may be deposited by the customer. Thus, a device for distinguishing the management target medium by using an image sensor, a magneto-resistive sensor, or the like has been provided in the financial device according to the related art. However, as printing technologies are developed in recent years, it may be difficult to distinguish the management target medium through naked eye or the sensors.

### BRIEF SUMMARY

Embodiments provide a medium processing apparatus and method and a financial device.

In one embodiment a medium processing apparatus comprises: a medium depositing and withdrawing unit through which a medium is deposited or withdrawn; a detection unit to acquire an image of the medium; a memory in which reference information, for determining whether the medium is rejected, is stored; and a control unit to extract a portion of information from the acquired image to compare the extracted information with the reference information stored in the memory.

In another embodiment, a medium processing method comprises: acquiring an image of a medium by a detection unit; extracting first information and second information for determining rejection of the medium from the acquired image of the medium by a control unit; reading reference information corresponding to the extracted first information from a memory; and comparing the second information with the reference information by the control unit to determine the rejection of the medium.

In further another embodiment, a financial device comprises: a customer information acquisition unit to acquire information of a customer; an user interface to display a menu or information for depositing or withdrawing, the user interface inputting or selecting a command or information for depositing or withdrawing; and a medium processing apparatus to store and deposit a medium deposited by the customer and dispense and withdraw the stored medium to the customer, wherein the medium processing apparatus acquires an image of the medium to extract a portion of information, thereby comparing the extracted information with reference information stored in a memory.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view of a financial device according to an embodiment.

FIG. 2 is a block diagram illustrating a constitution of a medium processing apparatus in the financial device according to an embodiment.

FIG. 3 is a view illustrating examples of first information and second information displayed on a medium.

FIG. 4 is a flowchart for explaining a medium processing method according to an embodiment.

### DETAILED DESCRIPTION

Hereinafter, exemplary embodiments of the present disclosure will be described with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Also, in the description of embodiments, terms such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, the former may be directly “connected,” “coupled,” and “joined” to the latter or “connected”, “coupled”, and “joined” to the latter via another component.

A financial device according to embodiments is a device that performs financial businesses, i.e., medium processing comprising processing such as deposit processing, giro receipt, or gift certificate exchange and/or processing such as withdrawal processing, giro dispensing, or gift certificate dispensing by receiving various media such as, e.g., paper moneys, bills, giros, coins, gift certificates, etc. For example, the financial device may comprise an automatic teller machine (ATM) such as a cash dispenser (CD) or a cash recycling device. However, the financial device is not limited to the above-described examples. For example, the financial device may be a device for automatically performing the financial businesses such as a financial information system (FIS).

Hereinafter, assuming that the financial device is the ATM, an embodiment will be described. However, this assumption is merely for convenience of description, and technical idea of the present disclosure is not limited to the ATM.

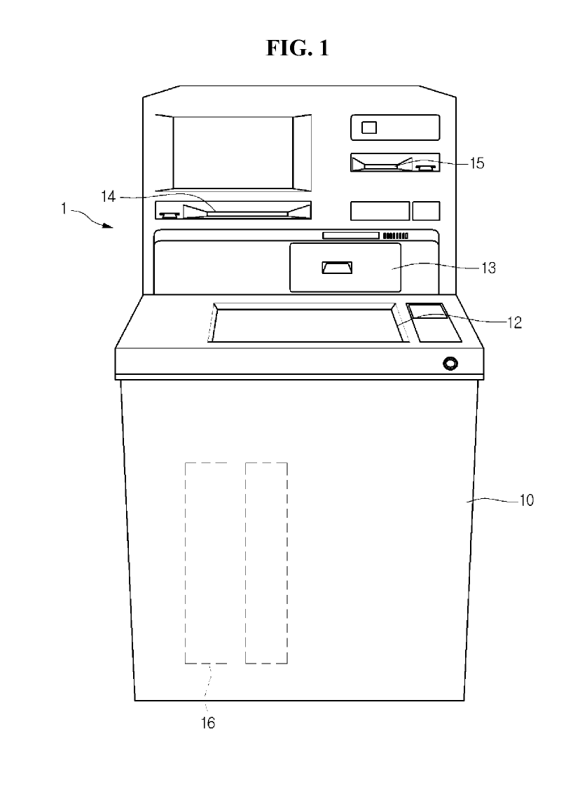

FIG. 1 is a perspective view of a financial device according to an embodiment.

Referring to FIG. 1, a financial device 1 according to an embodiment comprises a main body 10 in which a plurality of components are accommodated. The main body 10 comprises a medium depositing and withdrawing unit 13 for deposing and withdrawing a medium and at least one medium storage box 16 for storing the medium. The at least one medium storage box 16 may be separably mounted on the main body 10.

The medium depositing and withdrawing unit 13 comprises a medium accommodation space that is accessible by a customer. The medium accommodation space may be opened or closed by a blocking member such as a shutter or a cover. Alternatively, the medium accommodation space may be maintained in an opened state without being closed.

Also, according to a kind of the financial device 1, the financial device 1 may further comprise at least one of a bankbook entrance 14 for depositing or withdrawing a bankbook and a card entrance 15 for depositing or withdrawing a card. In the current embodiment, the bankbook entrance 14 or the card entrance 15 may be called as a customer information acquisition unit for acquiring information of a customer. The current embodiment is not limited to a kind of customer information acquisition unit. For example, the customer's information may be acquired by using information recorded in an RFID tag or USB or a customer's fingerprint.

Also, the financial device 1 may further comprise a user interface 12 that displays a menu or information for depositing or withdrawing and inputting or selecting a command or information for depositing or withdrawing.

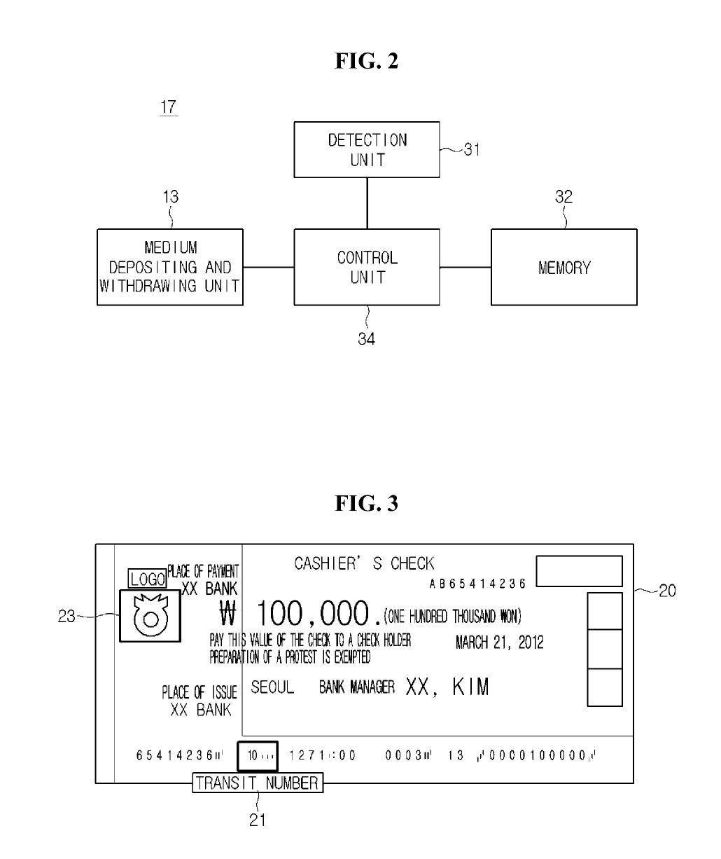

FIG. 2 is a block diagram illustrating a constitution of a medium processing apparatus in the financial device according to an embodiment, and FIG. 3 is a view illustrating examples of first information and second information displayed on a medium.

Referring to FIGS. 2 and 3, the financial device 1 according to the current embodiment may comprise a medium processing apparatus 17. The medium processing apparatus 17 may deposit a medium deposited by the customer and withdraw stored medium to the customer.

The medium processing apparatus 17 may comprise a medium depositing and withdrawing unit 13 for depositing and withdrawing the medium, a detection unit 31 for acquiring information of the medium, a memory 32 in which information to be compared with the information of the detected medium is stored, and a control unit 34 for comparing the information of the detected medium with the information stored in the memory 12 to determine whether the medium is authentic.

The detection unit 31 may comprise an optical character reader. The optical character reader may comprise a light emitting part and a light receiving part and acquire information of an image reflected from the medium or an image passing through the medium.

In the current embodiment, the medium may comprise information of an issuing institution of the medium. For example, if the medium is a check, the information of the issuing institution may be a bank's logo or a bank number, and if the medium is a security such as a gift certificate and the like, the information of the issuing institution may be a logo or an identification number of a company that issues the security. The current embodiment is not limited to a kind of the medium comprising the information of the issuing institution. Hereinafter, the check will be described an example.

The control unit 34 may acquire first information 21 displaying the issuing institution of the check and a second information 23 corresponding to the first information 21 from the image of the check 20 acquired by the detection unit 31.

In the current embodiment, the first information 21 may comprise a character, a number, or a combination of the character and the number and may be displayed on the medium to inform the issuing institution of the medium. The second information 23 may comprise a logo, a symbol, a character, a number, or a combination of the character and the number and may be displayed on the medium to inform issuing institution of the medium. For example, if the medium is the check, the first information 21 may be realized as a magnetic ink character recognition (MICR) character informing the issuing institution of the check, and the second information 23 may be a logo image informing the issuing institution of the check. For another example, the second information 23 may be a serial number that is combination information of the character and the number of the medium.

Here, the first information 21 corresponds to the second information 23 in a common medium. That is, if the medium is the check, the MICR character corresponding to the first information 21 informs the issuing institution of the check, and the logo image corresponding to the second information 23 also informs the issuing institution of the check. Here the issuing institutions of the check are identical. Thus, when the first information 21 and the second information 23 displayed in one medium are corresponding to each other, the relevant medium may be determined as a normally used medium. When the first information 21 and the second information 23 displayed in one medium are not corresponding to each other, the relevant medium may be determined as a medium (for example, a counterfeit note) that is abnormally distributed in s.

First reference information corresponding to the first information 21 and second reference information matching the first referent information are stored in the memory 32. The second reference information may be information to be compared with the acquired second information 23 of the medium.

For example, if the medium is the check, the information of the issuing institution corresponding to the MICR character informing the issuing institution of the MICR characters which are the first information 21 may be the first reference information, and the logo image of the issuing institution corresponding to the information of the issuing institution may be the second reference information. Here, the memory 32 may store the second reference information corresponding to the first reference information extracted from the medium without separately storing the first reference information. That is, the memory 32 may store the logo image of the issuing institution corresponding to the MICR character displaying the information of the issuing institution according to the issuing institutions.

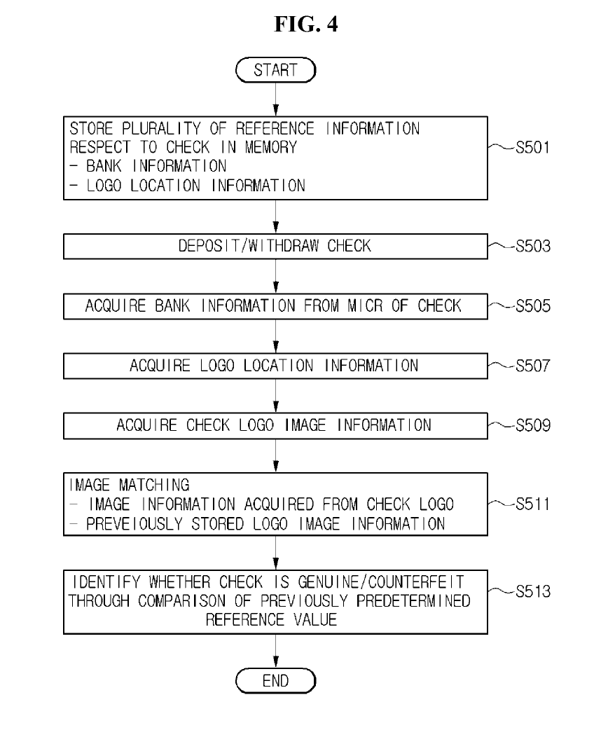

FIG. 4 is a flowchart for explaining a medium processing method according to an embodiment.

Referring to FIG. 4, in operation of S501, a plurality of reference information with respect to the check as a kind of the medium are previously stored in the memory 32.

As described above, the first reference information corresponding to the information of the issuing institution of the check and the second reference information corresponding to the first reference information are stored in the memory 32. In operation S503, the detection unit 31 may acquire the image of the check deposited through the medium depositing and withdrawing unit 13 or the image of the check to be dispensed through the medium depositing and withdrawing unit 13.

In operations S505, S507, and S509, the control unit 34 extracts first and second information from the acquired image of the check. Also, the control unit 34 determines the information of the issuing institution included in the extracted first information 21.

The control unit 34 determines the first reference information corresponding to the acquired information of the issuing institution of the check and then reads the second reference information matching the first reference information from the memory 32.

Then, in operation S511, the control unit 34 compares the acquired second information 23 with the second reference information read from the memory 32. In operation S513, the control unit 34 determines whether the medium is a check that is abnormally distributed in markets. That is, the control unit 34 may extract the MICR character displayed on the check to identify the issuing bank of the corresponding check and then compare a logo image of the issuing bank and the logo image displayed on the check to determine whether the corresponding check is the check (for example, a counterfeit note) that is abnormally distributed in markets.

In detail, the acquired second information 23 is pixelated and then binary-coded by the control unit 34. Then, the control unit 34 compares the second reference information stored in the memory 32 with the second information 23 to determine whether the check is authentic.

When the check is determined as a genuine check during deposition of the check, the check may be normally stored in the medium storage box 16. On the other hand, when the check is determined as a counterfeit check, the check may return to the medium depositing and withdrawing unit 16. Here, a notifying unit (not shown) may generate information for notifying a fact that the check is determined as the counterfeit check to return.

When the check is determined as a genuine check during withdrawal of the check, the check may be normally transferred to the medium depositing and withdrawing unit 16. On the other hand, when the check is determined as a counterfeit check, the check may be transferred to a reject box and then stored in the reject box without being transferred to the medium depositing and withdrawing unit.

Although the medium processing method during the deposition or withdrawal of the check is described in the current embodiment, the medium processing method may be identically applied to a medium processing apparatus or a counter for counting a medium. That is, the control unit 34 may acquire the information of the medium while the medium is countered and then determine whether the medium is authentic to allow the notifying unit to generate the information in which the medium is determined as a counterfeit check.

Even though all the elements of the embodiments are coupled into one or operated in the combined state, the present disclosure is not limited to such an embodiment. That is, all the elements may be selectively combined with each other without departing the scope of the invention. Furthermore, when it is described that one comprises (or comprises or has) some elements, it should be understood that it may comprise (or include or has) only those elements, or it may comprise (or include or have) other elements as well as those elements if there is no specific limitation. Unless otherwise specifically defined herein, all terms comprising technical or scientific terms are to be given meanings understood by those skilled in the art. Like terms defined in dictionaries, generally used terms needs to be construed as meaning used in technical contexts and are not construed as ideal or excessively formal meanings unless otherwise clearly defined herein.

Every one of the components may be also implemented by itself in hardware while the respective ones can be combined in part or as a whole selectively and implemented in a computer program having program modules for executing functions of the hardware equivalents.

Codes or code segments to constitute such a program may be easily deduced by a person skilled in the art. The computer program may be stored in the computer readable media, which in operation can realize the embodiments of the present disclosure. Examples of the computer readable media are magnetic recording media, optical recording media, and carrier wave media and more.

Although embodiments have been described with reference to a number of illustrative embodiments thereof, it will be understood by those skilled in the art that various changes in form and details may be made therein without departing from the spirit and scope of the invention as defined by the appended claims. Therefore, the preferred embodiments should be considered in descriptive sense only and not for purposes of limitation, and also the technical scope of the invention is not limited to the embodiments. Furthermore, is defined not by the detailed description of the invention but by the appended claims, and all differences within the scope will be construed as being comprised in the present disclosure.

What is claimed is:

1. A medium processing apparatus comprising:
a medium depositing and withdrawing unit through which a medium is deposited or withdrawn;
a detection unit to acquire an image of the medium;
a memory in which reference information, for determining whether the medium is rejected, is stored; and
a control unit that extracts a portion of information from the acquired image to compare the extracted information with the reference information stored in the memory.

2. The medium processing apparatus of claim 1, wherein the control unit extracts first information and second information from the acquired image of the medium,
the memory stores first reference information corresponding to the extracted first information and second reference information corresponding to the first reference information, and
the control unit compares the second information with the second reference information.

3. The medium processing apparatus of claim 2, wherein the control unit determines the first reference information corresponding to the first information and reads the second reference information corresponding to the first reference information from the memory to compare the second information with the second reference information.

4. The medium processing apparatus of claim 3, wherein the control unit allow the medium to return to the medium depositing and withdrawing unit when the second information does not match the second reference information while depositing of the medium.

5. The medium processing apparatus of claim 3, further comprising a reject box for separately storing the medium when the second information does not match the second reference information while withdrawing of the medium.

6. The medium processing apparatus of claim 2, wherein the first information comprises information comprising a character, a number, or a combination of the character and the number and is displayed on the medium to inform an issuing institution, and
the second information comprises information comprising a logo, a symbol, a character, a number or a combination of the character and the number and is displayed to inform the issuing institution.

7. The medium processing apparatus of claim 2, wherein the medium comprises a check, and the second information comprises a logo.

8. The medium processing apparatus of claim 2, wherein the second information comprises a serial number in which the character and the number are combined with each other.

9. The medium processing apparatus of claim 1, wherein the control unit extracts first information and second information from the acquired image of the medium,
the memory stores a second reference information corresponding to the extracted first information, and
the control unit compares the second information with the second reference information.

10. The medium processing apparatus of claim 9, wherein the first information comprises information comprising a character, a number, or a combination of the character and the number and is displayed on the medium to inform an issuing institution, and
the second information comprises information comprising a logo, a symbol, a character, a number or a combination of the character.

11. The medium processing apparatus of claim 9, wherein the control unit allow the medium to return to the medium depositing and withdrawing unit when the second information does not match the second reference information while depositing of the medium.

12. The medium processing apparatus of claim 9, further comprising a reject box for separately storing the medium when the second information does not match the second reference information while withdrawing of the medium.

13. A financial device comprising:
a customer information acquisition unit to acquire information of a customer;
an user interface to display a menu or information for depositing or withdrawing, the user interface inputting or selecting a command or information for depositing or withdrawing; and
a medium processing apparatus to store and deposit a medium deposited by the customer and dispense and withdraw the stored medium to the customer,
wherein the medium processing apparatus acquires an image of the medium to extract a portion of information, thereby comparing the extracted information with reference information stored in a memory.

14. The financial device of claim 13, wherein the medium processing apparatus comprises:
a detection unit to acquire the image of the medium; and
a control unit to compare the extracted information with the reference information stored in the memory.

15. The financial device of claim 14, wherein the control unit extracts first information and second information from the acquired image of the medium,
the memory stores second reference information for matching with the extracted first information, and
the control unit compares the second information with the second reference information.

16. The financial device of claim 15, wherein the memory further stores first reference information corresponding to the extracted first information, and
the control unit determines the first reference information corresponding to the extracted first information and reads the second reference information corresponding to the first reference information from the memory to compare the second information with the second reference information.

17. The financial device of claim 15, wherein, when the medium is a medium that is normally distributed in markets, the second information matches the second reference information, and
when the medium is a medium that is abnormally distributed in markets, the second information does not match the second reference information.

18. The financial device of claim 15, wherein when the medium is a medium that is normally distributed in markets, the second reference information corresponds to the extracted first information.

19. The financial device of claim 15, wherein the first information comprises information comprising a character, a number, or a combination of the character and the number and is displayed on the medium to inform an issuing institution, and
the second information comprises information comprising a logo, a symbol, a character, a number or a combination of the character and the number and is displayed to inform the issuing institution.

20. A medium processing method comprising:
acquiring an image of a medium by a detection unit;
extracting first information and second information for determining rejection of the medium from the acquired image of the medium by a control unit;
reading reference information corresponding to the extracted first information from a memory; and
comparing the second information with the reference information by the control unit to determine the rejection of the medium.
